(19) United States
(12) Patent Application Publication
(10) Pub. No.: US 2026/0265035 A1
(43) Pub. Date: Sep. 10, 2026

(54) WORK PLATFORM AND AUTOMATED WAREHOUSE

(71) Applicant: Murata Machinery, Ltd., Kyoto-shi, Kyoto (JP)

(72) Inventor: Takahiro MIURA, Kyoto (JP)

(73) Assignee: Murata Machinery, Ltd., Kyoto-shi, Kyoto (JP)

(21) Appl. No.: 19/166,494

(22) PCT Filed: Feb. 21, 2024
(86) PCT No.: PCT/JP2024/006378

§ 371 Date: Sep. 18, 2025

(30) Foreign Application Priority Data
Mar. 24, 2023 (JP) 2023-048818

(51) Int. Cl. B66F 11/04; B65G 1/04; B66F 17/00; E04G 3/20; E04G 5/14; F16H 21/54

(52) U.S. Cl. CPC B66F 11/04; B66F 17/006; E04G 3/20; E04G 5/144; F16H 21/54; B65G 1/0464

(57) ABSTRACT

A work platform includes a floor on which a worker is able to walk, one or a plurality of holes formed in the floor, one or a plurality of movable floors attached to the floor and movable between a closed position to cover the hole and an open position to open the hole, a safety fence switchable between a blocking state where the worker is prevented from entering the floor and an open state where the worker is allowed to enter the floor, and a linkage mechanism configured to move the movable floor in conjunction with an operation of the safety fence so that the movable floor is located at the open position when the safety fence is in the blocking state, and the movable floor is located at the closed position when the safety fence is in the open state.

### TECHNICAL FIELD

The present disclosure relates to a work platform and an automated warehouse.

### BACKGROUND ART

Conventionally, as described in Patent Literature 1, a warehouse system is known that includes a mobile robot that horizontally moves along each of a plurality of levels of shelves and vertically moves through an opening to move between the levels of the shelves. In this system, a horizontally oriented mechanical guard is mounted on the opening. With the mechanical guard covering the opening, the technician can walk through the passage for inspection and repairs.

### CITATION LIST

### Patent Literature

Japanese Unexamined Patent Publication No. 2021-505494

### SUMMARY OF INVENTION

### Technical Problem

In the above-described conventional system, for example, how to remove the mobile robot (transport cart) from an inspection and repair area has been studied so that a worker can work safely in the inspection and repair area. However, permission (or restriction of entry) for a worker to enter the area has not been studied. It cannot be said that the safety is secured when the worker enters the work passage.

The present disclosure describes a work platform and an automated warehouse that can ensure safety when a worker enters a work passage.

### Solution to Problem

A work platform according to one aspect of the present disclosure includes a floor on which a worker is able to walk, one or a plurality of holes formed in the floor, one or a plurality of movable floors attached to the floor and movable between a closed position to cover the hole and an open position to open the hole, a safety fence switchable between a blocking state where the worker is prevented from entering the floor and an open state where the worker is allowed to enter the floor, and a linkage mechanism configured to move the movable floor in conjunction with an operation of the safety fence so that the movable floor is located at the open position when the safety fence is in the blocking state, and the movable floor is located at the closed position when the safety fence is in the open state.

With this work platform, when the safety fence is in the open state, the movable floor is located at the closed position, and the hole is covered by the movable floor. Thus, it is possible to prevent the worker from entering the floor while the hole is opened. When the safety fence is in the blocking state, the movable floor is located at the open position, and the hole is opened. Thus, the hole can be utilized for its intended purpose. Opening and closing of the hole is performed in conjunction with the operation of the safety fence, and at the same time, the state of the safety fence is switched. Therefore, it is possible to secure the safety when the worker enters the work passage.

The plurality of holes may be formed in the floor, and the movable floor may be provided in each of the plurality of holes. The linkage mechanism may position each of the plurality of movable floors at the open position when the safety fence is in the blocking state, and may position each of the plurality of movable floors at the closed position when the safety fence is in the open state. In this case, even when the plurality of holes are formed in the floor, the holes are simultaneously covered by the movable floor by the linkage mechanism. Safety at the time of work can be secured only by operating the safety fence once. In addition, it is also possible to restore the holes to the original open state only by operating the safety fence once.

The linkage mechanism may include a loop-shaped member that connects the safety fence and the plurality of movable floors to each other. With the loop-shaped member, a reliable linkage mechanism can be achieved with a simple configuration.

The linkage mechanism may include a wire member as the loop-shaped member. The wire member occupies a small space and is also excellent in installation and operability (ease of movement at the installation location).

The linkage mechanism may include a turnbuckle attached between the wire members and provided at a position to cancel a weight of the safety fence. Manually moving the safety fence having a certain weight places a heavy burden on the worker. The turnbuckle is used for adjusting the length of the wire member, but can also be used as a counterweight of the safety fence to reduce the operation burden on the worker.

Any of the above work platforms may be applied to an automated warehouse including a plurality of levels of shelf portions in a vertical direction and configured to transfer an article to and from the shelf portions by a transport cart. In that case, the hole may be formed for the article to pass through the hole. When the safety fence is in the blocking state, the hole is opened, and the article can be conveyed in the vertical direction.

In the work platform applied to the automated warehouse, the transport cart may move in a horizontal direction along each of the plurality of levels of shelf portions, and the hole may be provided with an elevator capable of moving up and down while carrying the article placed thereon and passing through the hole, and capable of transferring the article to the transport cart. When the safety fence is in the blocking state, the hole is opened, and the article can be conveyed by the elevator.

In the work platform applied to the automated warehouse, the transport cart may move in a horizontal direction along each of the plurality of levels of shelf portions, and move between the plurality of levels of shelf portions by moving through the hole in the vertical direction. When the safety fence is in the blocking state, the hole is opened, and the transport cart can be moved in the vertical direction.

As another aspect of the present disclosure, there may be provided an automated warehouse including a plurality of levels of shelf portions provided in a vertical direction, a transport cart configured to transfer an article to and from the shelf portions, and any one of the above-described work platforms provided in a work passage that is a space overlapping with a moving passage of the transport cart in a horizontal direction. In this case, in the automated warehouse, it is possible to prevent the worker from entering the floor while the hole is opened. Further, it is possible to secure the safety when the worker enters the work passage.

### Advantageous Effects of Invention

According to the present disclosure, opening and closing of a hole is performed in conjunction with an operation of a safety fence, and at the same time, the state of the safety fence is switched. Therefore, it is possible to secure the safety when a worker enters the work passage.

### BRIEF DESCRIPTION OF DRAWINGS

FIG. 1 is a schematic front view illustrating an automated warehouse according to an embodiment of the present disclosure.

FIG. 2 is a perspective view illustrating a work platform incorporated in the automated warehouse of FIG. 1.

FIG. 3 is a perspective view illustrating an example of a support structure of a floor in the work platform.

FIG. 4 is a view describing movement of a movable floor by a linkage mechanism of the work platform.

FIG. 5 is a view describing a mechanism for simultaneously moving all movable floors by loop-shaped wire members.

FIG. 6 is a view illustrating a safety fence in a closed state.

FIG. 7 is a view illustrating the safety fence in an open state.

FIG. 8 is a schematic front view illustrating an automated warehouse according to another embodiment of the present disclosure.

### DESCRIPTION OF EMBODIMENTS

An embodiment of the present disclosure will be described below with reference to the drawings. In the description of the drawings, the same elements are denoted by the same reference signs and an overlapping description is omitted.

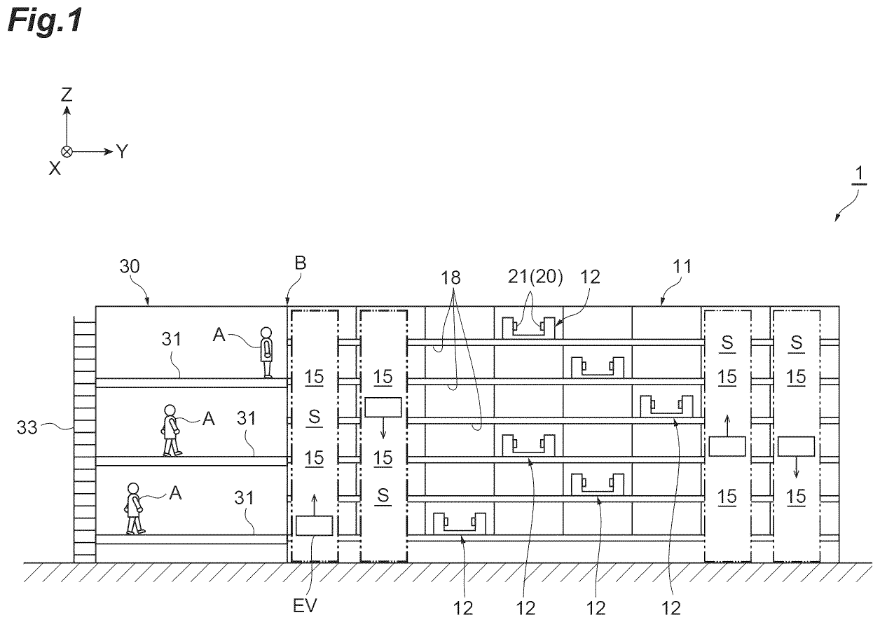

As illustrated in FIG. 1, the automated warehouse 1 is a facility capable of storing a plurality of articles and automatically unloading and loading articles in response to a request from an external system. Carrying-in of an item W into the automated warehouse 1 and carrying-out of an article from the automated warehouse 1 are performed by a conveyor system (not illustrated). The article (or item) is, for example, a case, a tray, a cardboard box, a folding container, or the like that can store a product. Note that, in the following description, one horizontal direction is defined as an X direction, a horizontal direction orthogonal to the X direction is defined as a Y direction, and a vertical direction orthogonal to both the X direction and the Y direction is defined as a Z direction.

The automated warehouse 1 includes a rack 11 that stores articles, and a plurality of transport vehicles (transport carts) 12 that transport the articles. Although not illustrated, the automated warehouse 1 includes a loading station, an unloading station, a loading lifting device, an unloading lifting device, and the like. These devices include known components such as conveyors and lifters, and can transfer articles.

The rack 11 includes shelf portions 18 on which articles are placed. The shelf portions 18 extend in the Y direction. A plurality of shelf portions 18 is arranged in the X direction, for example, and is arranged so as to face each other in the X direction across a traveling area of the transport vehicles 12. A plurality of levels of the shelf portions 18 is arranged in the Z direction (vertical direction). The shelf portions 18 are configured to be able to place a plurality of articles in the Y direction. A buffer conveyor (not illustrated) for temporarily placing an article may be provided at an end on one side in the Y direction of each level of the shelf portions 18 of the rack 11.

A plurality of transport vehicles 12 are provided in one-by-one correspondence to the plurality of levels of the shelf portions 18. The transport vehicle 12 can reciprocate along the Y direction at the corresponding height of each level of the shelf portions 18. The transport vehicle 12 is a shuttle cart that holds and transports an article. The transport vehicle 12 can travel on a pair of rails (not illustrated) laid along the Y direction at height positions corresponding to each level of the shelf portions 18. The transport vehicle 12 includes a transfer device 20 capable of transferring an article to the shelf portion 18.

The transfer device 20 is, for example, a rear hook type transfer device. The transfer device 20 includes a pair of arms 21 that advance and retreat along the X direction, and hooks (not illustrated) that are provided at a front end and a rear end of each arm 21 and are turnable on a plane orthogonal to the X direction. The type of the transfer device 20 is not particularly limited, and may be various types of transfer devices such as a side clamp transfer device.

Each transport vehicle 12 horizontally moves along each of the plurality of levels of shelf portions 18. Each transport vehicle 12 transfers an article to and from the shelf portions 18.

The automated warehouse 1 of the present embodiment includes a plurality of (for example, four) elevating spaces S extending in the vertical direction within the rack 11. Each of the elevating spaces S is provided with an elevator EV on which an article is placed and which moves up and down in the elevating space S. Each elevator EV can transfer an article to a transport vehicle 12.

The automated warehouse 1 includes, for example, a maintenance frame 30 provided adjacent to the rack 11 in the Y direction. The frame 30 includes a plurality of access passages 31 provided at predetermined pitches (intervals) in the vertical direction, and ladders 33 for a worker A to go up and down with respect to the access passages 31. An interval between the access passages 31 that are vertically adjacent to each other has a height at which the worker A can walk. For example, the interval may have a height corresponding to a plurality of shelf portions 18 so that one access passage 31 is provided corresponding to the four levels of shelf portions 18.

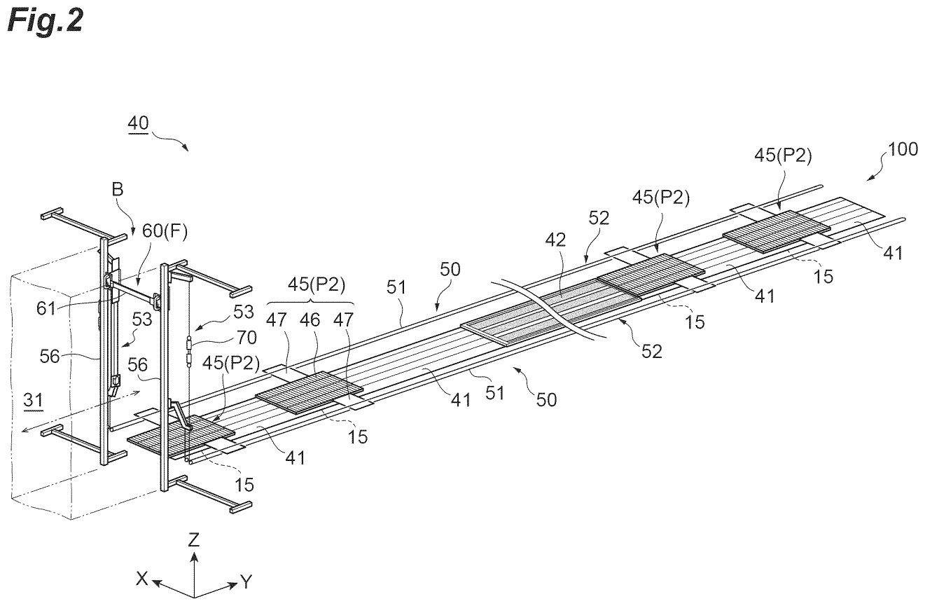

The rack 11 includes a plurality of work passages 100 (see FIG. 2) provided at positions different from the shelf portions 18 and extending in the Y direction in plan view. As illustrated in FIG. 2, one work passage 100 is continuous with one access passage 31 in the Y direction. That is, the plurality of work passages 100 provided in the rack 11 and the plurality of access passages 31 provided in the frame 30 correspond to each other on a one-to-one basis, and are provided in the same number. Each work passage 100 is provided at a position that does not interfere with the plurality of shelf portions 18 and the traveling area of the transport vehicle 12 in plan view. Each of the work passages 100 intersects with the above-described elevating space S.

The automated warehouse 1 includes, corresponding to each work passage 100, a work platform 40 so that the worker A can work safely in the work passage 100. The work platform 40 is provided in a work passage that is a space overlapping with a moving passage (corresponding to the traveling region) of the transport vehicle 12 in the horizontal direction. That is, the work platform 40 of the present embodiment is applied to the automated warehouse 1. Basically, the timing at which the worker A performs work on the work platform 40 and the timing at which the transport vehicle 12 and the mobile cart such as the elevator EV operate are completely divided (do not overlap). However, since the work platform 40 is permanently installed in the automated warehouse 1, each configuration described in detail below is installed in a space that does not interfere with the mobile cart (particularly when the movable floor 45 is located at an open position P1).

Hereinafter, the work platform 40 of the present embodiment will be described with reference to FIG. 2 and subsequent drawings. As illustrated in FIG. 2, the work platform 40 extends in the Y direction in the rack 11. The length of the work platform 40 in the Y direction may correspond to or be shorter than the length of the rack 11 in the Y direction. That is, the work platform 40 may be provided over the entire rack 11 in the Y direction, or need not be provided over the entire rack 11 in the Y direction. The work platform 40 includes a first floor 41 and a second floor 42 where the worker A can walk, and a plurality of (for example, four) holes 15 formed in the first floor 41 and the second floor 42. The work platform 40 intersects with the four elevating spaces S, and rectangular holes 15 are formed at the intersection. Therefore, the number of the holes 15 is equal to the number of the elevating spaces S arranged in the Y direction (intersecting the work passage 100).

Since the elevating space S allows the elevator EV to pass, the size of the hole 15 is larger than that of the elevator EV. The hole 15 is larger than the article and are formed for the article to pass through the hole 15.

The plurality of first floors 41 and the plurality of second floors 42 are horizontally installed in a region other than the holes 15, and the worker A can safely walk on these floors. The first floor 41 is made of a flat plate material, and the second floor 42 is made of steel members assembled in a lattice shape. For example, the first floor 41 is constituted of a sheet metal member and the second floor 42 is constituted of a grating, but the first floor 41 and the second floor 42 are not necessarily divided, and may be integrally formed of similar members.

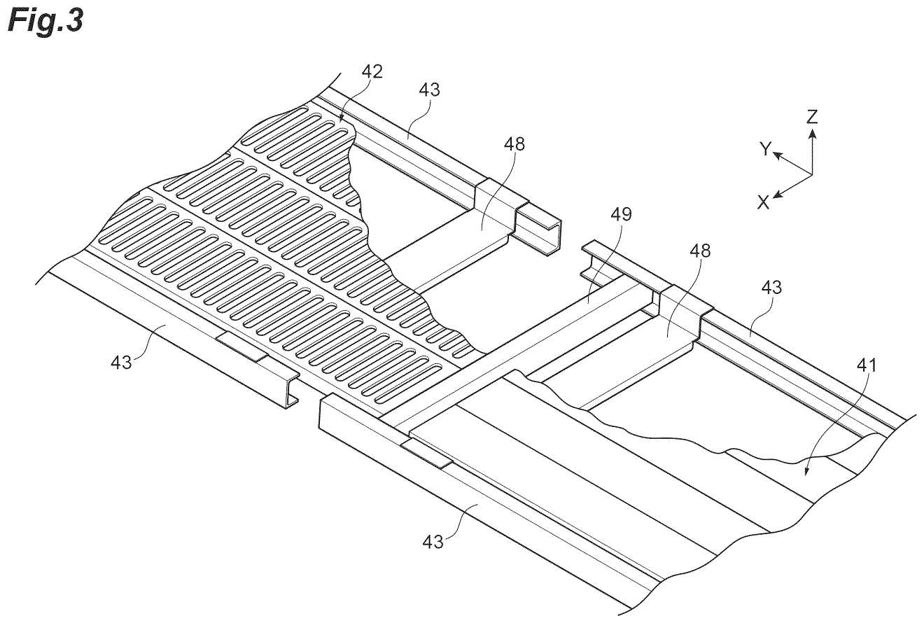

FIG. 3 is a perspective view illustrating an example of a support structure of a floor in the work platform 40. As illustrated in FIG. 3, the first floor 41 and the second floor 42 are bridged between main support members 43, which are a pair of steel members extending in the Y direction. More specifically, the pair of main support members 43 have a predetermined interval (corresponding to the width of the work passage 100) in the X direction, and extend parallel to each other. The pair of main support members 43 is attached to and integrated with at least one of a structural member constituting the rack 11 (shelf portions 18) or a structural member constituting the traveling rail of the transport vehicle 12. A plurality of sub support members 48 are bridged between the pair of main support members 43 at appropriate intervals in the Y direction. The first floor 41 and the second floor 42 are fitted onto the support surfaces of the sub support members 48 extending in the X direction. The first floor 41 and the second floor 42 are fixed to each other while being supported by the plurality of sub support members 48. Note that, for example, a rectangular columnar horizontal member 49 extending in the X direction may be provided between the first floor 41 and the second floor 42.

The work platform 40 further includes a plurality of movable floors 45 attached to at least one of the first floor 41 or the second floor 42 and capable of covering the holes 15. The work platform 40 of the present embodiment includes four movable floors 45 having a constant interval corresponding to the positions of the holes 15. Each movable floor 45 has a rectangular shape corresponding to the shape of the holes 15, and includes a movable floor plate 46 having a size that can exactly cover the size of the holes 15, and a pair of connecting portions 47 fixed to both end portions of the movable floor plate 46 in the X direction.

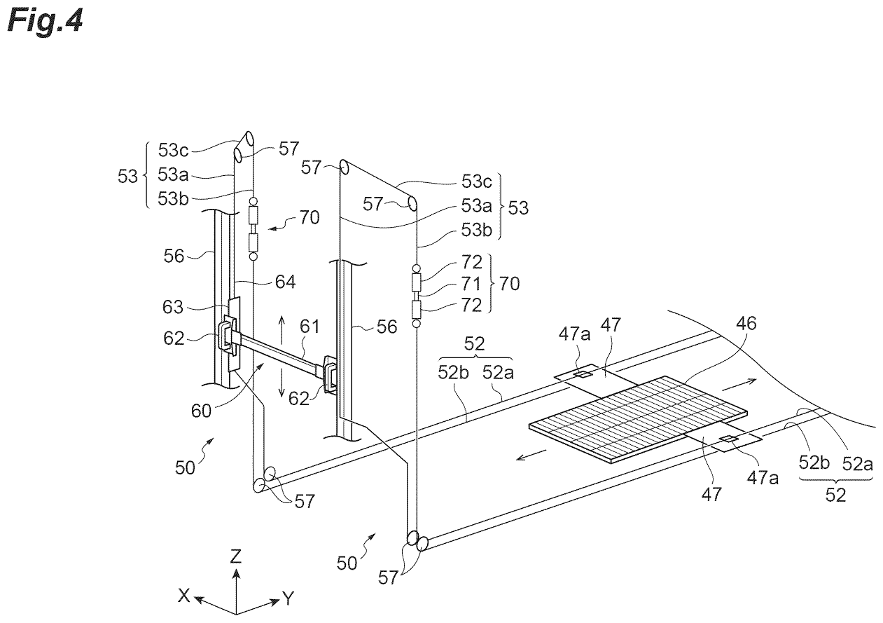

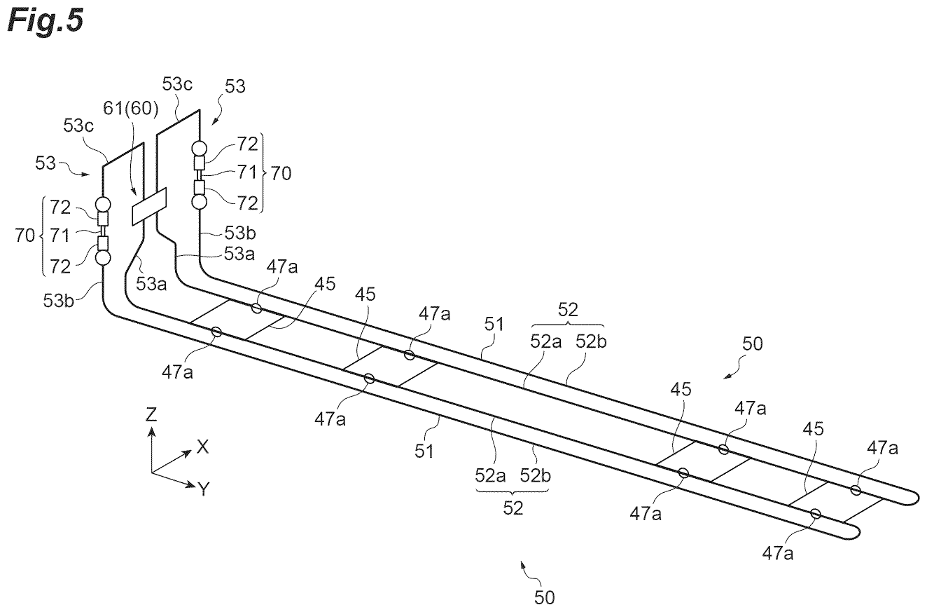

As illustrated in FIGS. 2 and 5, the work platform 40 includes a pair of linkage mechanisms 50 that connect the plurality of movable floors 45 to each other. The pair of linkage mechanisms 50 is separated in the X direction, and continuously connects the plurality of movable floors 45 through vicinities of both end portions (or outer sides of both end portions) of the plurality of movable floors 45 in the X direction. The linkage mechanisms 50 each include a wire member 51 that is a loop-shaped member. A pair of wire members 51 extends on both sides of the plurality of movable floors 45. Each wire member 51 is fixed to the pair of connecting portions 47 fixed to the movable floors 45 via, for example, fixtures 47a (see FIG. 4).

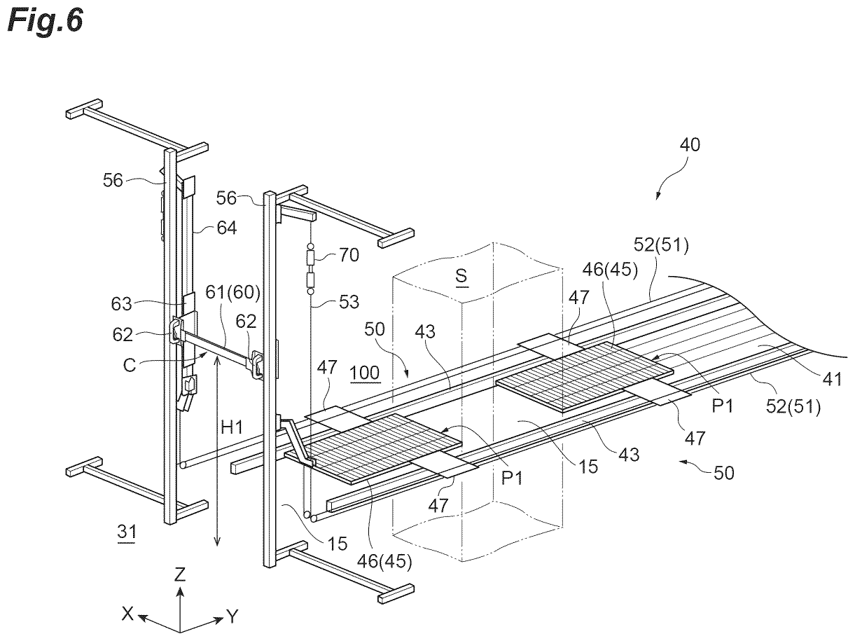

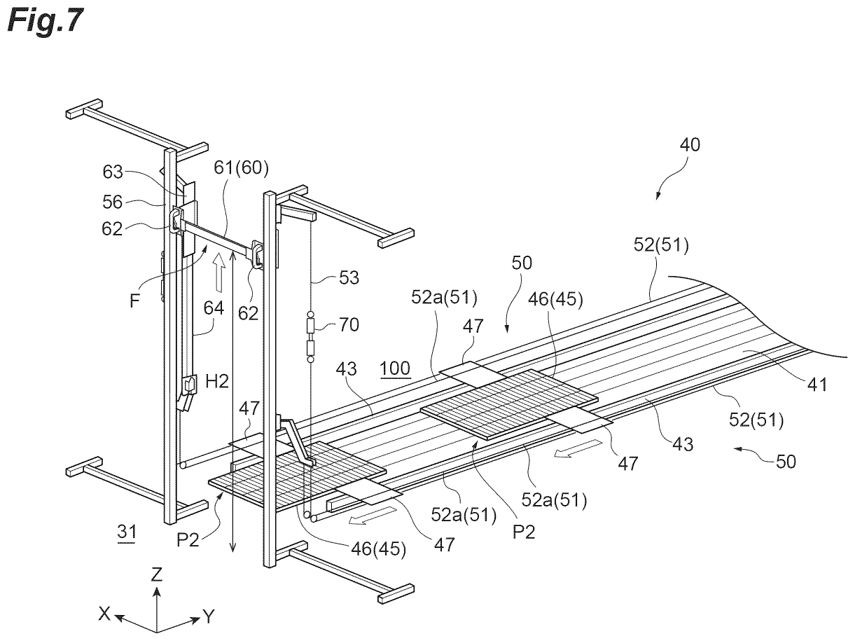

Each movable floor 45 is installed, for example, at substantially the same height as the second floor 42 (at a position slightly higher than the first floor 41), and is attached, for example, on the pair of main support members 43 so as to be slidable in the Y direction. The movable floor 45 slides on the first floor 41 to open and close the hole 15. Each movable floor 45 is movable between a closed position P2 (see FIG. 7) where each hole 15 is covered and an open position PI (see FIG. 6) where each hole 15 is opened.

The pair of main support members 43, the first floor 41, the second floor 42, and the movable floors 45 are provided at the same position as a moving passage, that is, a traveling rail (not illustrated) in the horizontal direction of the transport vehicle 12 in the X direction. However, in order to avoid interference with these, the pair of main support members 43, the first floor 41, the second floor 42, and the movable floors 45 are arranged at positions different from the traveling rails in the Z direction, for example. The pair of main support members 43, the first floor 41, the second floor 42, and the movable floors 45 may be installed slightly below the traveling rail.

As illustrated in FIG. 4, the work platform 40 further includes a safety fence 60 for operating the plurality of movable floors 45 via the linkage mechanisms 50. The safety fence 60 is provided at an end of the work platform 40 on the frame 30 side in the Y direction. In other words, the safety fence 60 is provided near a boundary B between the rack 11 and the frame 30 (see FIG. 1). The safety fence 60 is provided near the boundary between the work passage 100 and the access passage 31. The safety fence 60 includes a blocking bar 61 horizontally bridged between a pair of columns 56 defining widths of the work passage 100 and the access passage 31, a pair of handles 62 provided at both ends of the blocking bar 61 in the X direction, and a pair of slide units 63 fixed to the columns 56 and vertically movable with respect to a pair of rails 64 extending in the Z direction. Each handle 62 is fixed on each slide unit 63. The handle 62 has, for example, a snatch lock mechanism, and when worker A grips both handles 62 with both hands, the lock is released and the handles can move up and down.

The wire member 51 of the linkage mechanism 50 provided on one side in the X direction is connected to an upper end and a lower end of the slide unit 63 located on one side in the X direction. The wire member 51 of the linkage mechanism 50 provided on the other side in the X direction is connected to the upper end and the lower end of the slide unit 63 located on the other side in the X direction. As illustrated in FIG. 5, each wire member 51 has a lateral portion 52 extending in the X direction and a vertical portion 53 extending in the Z direction along the safety fence 60. The lateral portion 52 includes a direct coupling portion 52a coupled to the plurality of movable floors 45 and an opposite portion 52b extending in parallel with the direct coupling portion 52a. The movable floors 45 are not connected to the opposite portion 52b. The direct coupling portion 52a and the direct coupling portion 52a are supported by a support plate material, a support roller, or the like (not illustrated). As illustrated in FIGS. 4 and 5, the vertical portion 53 includes a direct coupling portion 53a coupled to the upper end and the lower end of the slide unit 63, a turnaround portion 53c supported by a plurality of support rollers 57 to change the direction, and an opposite portion 53b connecting the turnaround portion 53c and an opposite portion 52b of the lateral portion 52. These portions are continuously connected in a loop shape. Except for a bent portion by the support rollers 57 such as the turnaround portion 53c, the position and route of the wire member 51 are set so that the wire member 51 extends as linearly as possible.

The linkage mechanisms 50 each include a turnbuckle 70 attached so as to be interposed in a middle portion of the opposite portion 53b of each linkage mechanism 50. A pair of turnbuckles 70 is provided corresponding to the pair of linkage mechanisms 50. Each turnbuckle 70 includes one rod-shaped adjustment rod 71 and a pair of coupling screw portions 72 provided at both ends of the adjustment rod 71 and meshing with the adjustment rod 71. The pair of coupling screw portions 72 has female screw portions in opposite directions, and when the worker A grips the adjustment rod 71 at the center and rotates the adjustment rod around the axis, the interval between ring portions at both ends coupled to the wire member 51 changes. The turnbuckle 70 is used to adjust the tension of the wire member 51 by adjusting the loop length of the wire member 51 when the wire member 51 is attached.

The identical article is applied as each turnbuckle 70. The total weight obtained by adding the weights of the two turnbuckles 70 is set to be a value that is balanced with or close to the total weight of the safety fence 60. The safety fence 60 is provided in the middle of the direct coupling portion 53a, the pair of turnbuckles 70 is provided in the middle of the opposite portion 53b, and the direct coupling portion 53a and the opposite portion 53b are located opposite to each other with the turnaround portion 53c interposed therebetween. The pair of turnbuckles 70 is provided at a position to cancel the weight of the turnbuckle 70 by the action of a force similar to the principle of pulley. Note that the term “cancel” as used herein means to reduce the weight of the turnbuckle 70, and does not strictly mean elimination (reduction to zero) of the weight of the turnbuckle 70. In addition, the length (how long the wire member 51 extends) can be confirmed by viewing the position of the turnbuckle 70. As described above, the turnbuckle 70 has a length (tension) adjustment function of the wire member 51, a function as a counterweight, and a length (tension) monitoring function. The turnbuckle 70 is provided with a lower limit position and an upper limit position.

The method (procedure) for attaching the linkage mechanism 50, i.e., the wire member 51, is not particularly limited, but an example thereof will be described. First, the two wires are each laid in a loop shape and coupled to the turnbuckle 70. At this time, the tension of each wire member 51 is 0 kgf (no tension). A plurality of portions of the wire member 51 may be fixed with clips or the like. Subsequently, the wire member 51 is tensioned by tightening the turnbuckle 70. For example, in a state where the turnbuckle 70 is at the lower limit position, each portion of the wire member 51 is fastened to the movable floor 45 (the connecting portion 47) at the closed position P2. Then, the safety fence 60 is positioned at the position of an open state F (second height H2 described later), and the wire member 51 is fastened to the turnbuckle 70.

In the work platform 40 of the present embodiment, as illustrated in FIG. 4, the plurality of movable floors 45 move all at once in conjunction with the operation of the safety fence 60 (only one movable floor 45 is illustrated in FIG. 4). More specifically, at the open position P1, each movable floor 45 is located on the side farther from the column 56 (the safety fence 60 or the boundary B) with respect to each hole 15. When the worker A grips the handle 62 and lifts the safety fence 60, the movable floor 45 is pulled frontward (toward the column 56) via the direct coupling portion 53a and the direct coupling portion 52a, and moved to the closed position P2. When the worker A grips the handle 62 and pulls down the safety fence 60, the movable floor 45 is pulled from the back side (away from the column 56) via the turnaround portion 53c, the opposite portion 53b, and the opposite portion 52b and moved to the open position P1. In this manner, the plurality of movable floors 45 moves between the open position PI where the holes 15 are opened and the closed position P2 where the holes 15 are covered in accordance with the operation of the safety fence 60.

In particular, in the work platform 40, the position (state) of the safety fence 60 and the position of each movable floor 45 are set in a devised relationship. The position of the safety fence 60 (blocking bar 61) will be described with reference to FIGS. 6 and 7. As described above, the blocking bar 61 is provided so as to cross between the pair of handles 62. In the blocking state C illustrated in FIG. 6, the blocking bar 61 is located in front of the body of the worker A (for example, about the height of the waist). When the safety fence 60 is in the blocking state C, the plurality of movable floors 45 are located at the open positions P1, and the plurality of holes 15 is opened. In this state, the elevator EV is capable of moving up and down in the elevating space S (see FIG. 1). As illustrated in FIG. 7, when the safety fence 60 is lifted by the worker A to be in the open state F, the plurality of movable floors 45 are located at the closed positions P2, and the plurality of holes 15 is closed. In this state, the elevator EV is unable to move up and down in the elevating space S. Then, the worker A can enter the work passage 100 from the access passage 31 side. The work platform 40 then provides a safe walkway.

A first height H1 of the blocking bar 61 when the safety fence 60 is in the blocking state C is set to a height that prevents the worker A from entering. A second height H2 of the blocking bar 61 when the safety fence 60 is in the open state F is set to a height that allows entry of the worker A. That is, the open state F can also be said to be a retracted state where the blocking bar 61 is retracted, and the blocking bar 61 in the retracted state allows the worker A to pass without any trouble. In addition, the second height H2 is set to a height at which the worker A can reach the handle 62 by extending both hands. The first height H1 is set to, for example, about 1 m, and the second height H2 is set to, for example, about 2 m. The difference between the second height H2 and the first height H1 is set to about 1 m. The second height H2 only needs to be set to a height suitable for allowing the worker A to enter, and the first height HI only needs to be set to a height lower than the second height H2 and suitable for preventing the worker A from entering.

As described above, the linkage mechanism 50 can be switched between the blocking state C in which the worker A is prevented from entering and the open state F in which the worker A is allowed to enter. Then, the linkage mechanism 50 moves the movable floors 45 in conjunction with the operation of the safety fence 60 so that the movable floors 45 are located at the open positions P1 when the safety fence 60 is in the blocking state C and the movable floors 45 are located at the closed positions P2 when the safety fence 60 is in the open state F.

The work platform 40 described above is used, for example, in the automated warehouse 1 when the transport vehicle 12, the elevator EV, or the like stops in the rack 11 for some reason, or at the time of maintenance. The work platform 40 completely separates the movement of the person such as the worker A and the movement of the mobile cart such as the transport vehicle 12 and the elevator EV by the mechanism described above. Note that, when the elevator EV stops at a position that overlaps with the work passage 100 while moving up or down, the holes 15 cannot be closed even if the worker A operates the safety fence 60 (the movable floor 45 interferes with the elevator EV and cannot move). Even in that case, as an emergency response, the worker A can enter the work passage 100 through under the blocking bar 61.

With the work platform 40 of the present embodiment, when the safety fence 60 is in the open state F, the movable floors 45 are located at the closed positions P2, and the holes 15 are covered by the movable floors 45. Thus, it is possible to prevent the worker A from entering the floor while the holes 15 are opened. When the safety fence 60 is in the blocking state, the movable floors 45 are located at the open positions P1, and the holes 15 are opened. Thus, the holes 15 can be utilized for their intended purpose. Opening and closing of the hole 15 is performed in conjunction with the operation of the safety fence 60, and at the same time, the state of the safety fence 60 is switched. Therefore, it is possible to secure the safety when the worker A enters the work passage 100.

The movable floor 45 is provided in each of the plurality of holes 15, and the linkage mechanism 50 positions the plurality of movable floors 45 at the open positions P1 when the safety fence 60 is in the blocking state, and positions the plurality of movable floors 45 at the closed positions P2 when the safety fence 60 is in the open state F. Accordingly, even when the plurality of holes 15 is formed in the floor portion, the holes 15 are simultaneously covered by the movable floors 45 by the linkage mechanism 50. Safety at the time of work can be secured only by operating the safety fence 60 once. In addition, it is also possible to restore the holes 15 to the original open state only by operating the safety fence 60 once.

The linkage mechanism 50 includes a loop-shaped member that connects the safety fence 60 and the plurality of movable floors 45 to each other. With the loop-shaped member, the reliable linkage mechanism 50 can be achieved with a simple configuration.

The linkage mechanism 50 includes a wire member 51 as the loop-shaped member. The wire member 51 occupies a small space and is also excellent in installation and operability (ease of movement at the installation location).

The linkage mechanism 50 includes a turnbuckle 70 attached between the wire members 51 and provided at a position to cancel the weight of the safety fence 60. Manually moving the safety fence 60 having a certain weight places a heavy burden on the worker A. The turnbuckle 70 is used for adjusting the length of the wire member 51, but can also be used as a counterweight of the safety fence 60 to reduce the operation burden on the worker A.

In the automated warehouse 1 of the present embodiment, it is possible to prevent the worker A from entering the floor while the holes 15 are opened. Further, it is possible to secure the safety when the worker A enters the work passage 100. According to the automated warehouse 1, when the safety fence 60 is in the blocking state, the holes 15 are opened, and the article can be conveyed in the vertical direction. More specifically, when the safety fence 60 is in the blocking state, the holes 15 are opened, and the article can be conveyed by the elevator EV.

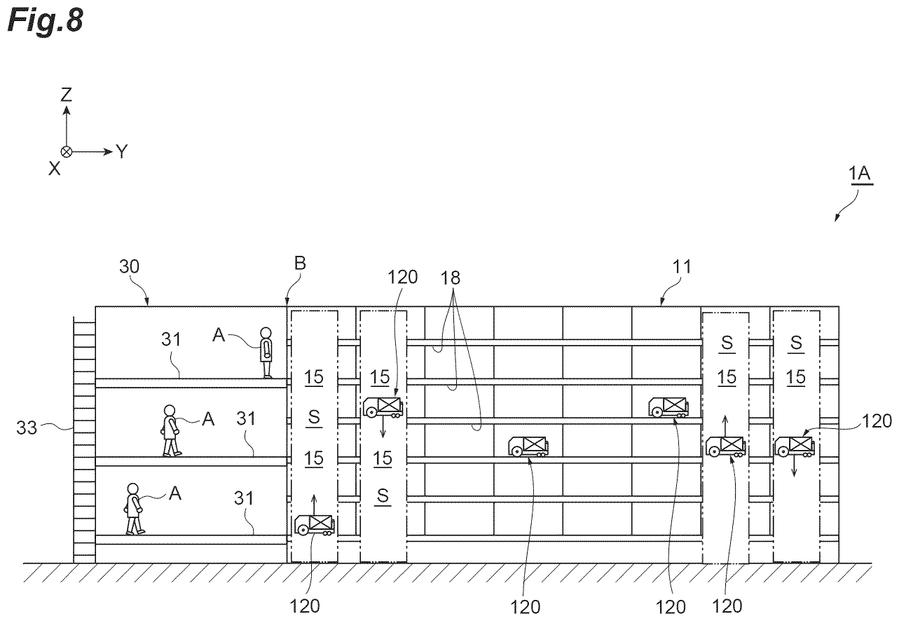

Although the embodiment of the present disclosure has been described above, the present invention is not limited to the above embodiment. For example, as illustrated in FIGS. 8, 40 may be applied to the automated warehouse 1A in which a transport vehicle (transport cart) 120 moves in the horizontal direction along each of the plurality of levels of shelf portions 18 and moves between the plurality of levels of shelf portions by moving through the elevating space S, that is, the holes 15 in the vertical direction. Also in the automated warehouse 1A, operational effects similar to those of the automated warehouse 1 are exhibited. When the safety fence 60 is in the blocking state C, the holes 15 are opened, and the transport vehicle 120 can be moved in the vertical direction.

The position and the route (path) of the wire member 51 may be appropriately changed or set. The locking mechanism in the handle 62 may be replaced with another mechanism. It is preferable that some fixing mechanism be provided so that the safety fence 60 and the linkage mechanism 50 do not move unintentionally.

The floor may include one type of flooring. The configuration of the movable floor 45 is also not particularly limited. The flooring only needs to be slidable in the Y direction, and to be provided with a mechanism capable of opening and closing the holes 15, and various known mechanisms may be adopted.

The linkage mechanism 50 may include a chain, a timing belt, and the like as a loop-shaped member. In addition, the linkage mechanism 50 is not limited to the case of including the loop-shaped member, and may include a shaft, a bar-shaped member, or the like. If these rigid members are used, the movable floor 45 can be moved not by pulling of the linear members but by pushing and pulling of the members.

The operation of the safety fence and the linkage mechanism is not limited to the operation by the worker, and the safety fence and the linkage mechanism may be electrically driven by including a drive unit and a control unit.

In one work platform, there may be only one hole. In that case, there is also one movable floor.

The work platform 40 may be applied to another warehouse or the like other than the automated warehouse.

### REFERENCE SIGNS LIST

1, 1A Automated warehouse
12 Transport vehicle (transport cart)
15 Hole
18 Shelf portion
31 Access passage
40 Work platform
41 First floor
42 Second floor
45 Movable floor
50 Linkage mechanism
51 Wire member (loop-shaped member)
60 Safety fence
61 Blocking bar
62 Handle
70 Turnbuckle
100 Work passage
120 Transport vehicle (transport cart)
A Worker
C Blocking state
EV Elevator
F Open state
P1 Open position
P2 Closed position

1. A work platform comprising:
a floor on which a worker is able to walk;
one or a plurality of holes formed in the floor;
one or a plurality of movable floors attached to the floor and movable between a closed position to cover the hole and an open position to open the hole;
a safety fence switchable between a blocking state where the worker is prevented from entering the floor and an open state where the worker is allowed to enter the floor; and
a linkage mechanism configured to move the movable floor in conjunction with an operation of the safety fence so that the movable floor is located at the open position when the safety fence is in the blocking state, and the movable floor is located at the closed position when the safety fence is in the open state.

2. The work platform according to claim 1, wherein
the plurality of holes is formed in the floor,
the movable floor is provided in each of the plurality of holes, and
the linkage mechanism positions each of the plurality of movable floors at the open position when the safety fence is in the blocking state, and positions each of the plurality of movable floors at the closed position when the safety fence is in the open state.

3. The work platform according to claim 2, wherein the linkage mechanism includes a loop-shaped member that connects the safety fence and the plurality of movable floors to each other.

4. The work platform according to claim 3, wherein the linkage mechanism includes a wire member as the loop-shaped member.

5. The work platform according to claim 4, wherein the linkage mechanism includes a turnbuckle attached between the wire members and provided at a position to cancel a weight of the safety fence.

6. The work platform according to claim 1, the work platform being applied to an automated warehouse including a plurality of levels of shelf portions in a vertical direction and configured to transfer an article to and from the shelf portions by a transport cart, wherein
the hole is formed to allow the article to pass through the hole.

7. The work platform according to claim 6, wherein
the transport cart moves in a horizontal direction along each of the plurality of levels of shelf portions, and
the hole is provided with an elevator capable of moving up and down and while carrying the article placed thereon and passing through the hole, and capable of transferring the article to the transport cart.

8. The work platform according to claim 6, wherein the transport cart moves in a horizontal direction along each of the plurality of levels of shelf portions, and moves between the plurality of levels of shelf portions by moving through the hole in the vertical direction.

9. An automated warehouse comprising:
a plurality of levels of shelf portions provided in a vertical direction;
a transport cart configured to transfer an article to and from the shelf portions; and
the work platform according to claim 1 provided in a work passage that is a space overlapping with a moving passage of the transport cart in a horizontal direction.
